(19) United States
(12) Patent Application Publication
(10) Pub. No.: US 2017/0282213 A1
(43) Pub. Date: Oct. 5, 2017

(54) SYSTEMS AND PROCESSES FOR MIXING WET AND DRY MATERIALS

(71) Applicant: Bepex International, LLC, Minneapolis, MN (US)

(72) Inventors: Peter M. Koenig, Minneapolis, MN (US); Joseph P. McHale, Minneapolis, MN (US); Michael D. White, Maple Grove, MN (US)

(21) Appl. No.: 15/091,052

(22) Filed: Apr. 5, 2016

(51) Int. Cl. B05D 1/34

(52) U.S. Cl. CPC B05D 1/34; B05D 2401/00

(57) ABSTRACT

A coating apparatus with a coating chamber configured for receiving a particulate, a horizontally-oriented rotor having a plurality of paddles mounted thereon, the rotor and the paddles defining a liquid injection path fluidly connected to a liquid injection system, the liquid injection system arranged to supply a liquid under conditions suitable to continuously coat the particulate in a manner that substantially reduces formation of caked solid-liquid mixture on inner walls of the coating chamber.

### FIELD

The present disclosure relates to systems and processes for mixing, coating, and/or hydrating dry materials with liquids.

### BACKGROUND

In coating and mixing processes, a solid product is often coated with a liquid (e.g., sprayed or atomized liquid) and then heated, dried, cooled, and/or crystallized to form a product. Such coating and mixing processes can be used in a range of applications including converting drink mixes into “instant” form, coating solids with a hydrophobic coating to reduce moisture intrusion, coating food products with shortening or oil to facilitate dispersion of pigments and the like.

Applicant itself is a leader in the production of food and chemical processing equipment and systems that include thermal processing, polymer processing, drying, agglomeration, size reduction, compaction, briquetting, liquid/solid separation, mixing and blending for the food, chemical and polymer markets. An example of such coating and mixing apparatus has been described in U.S. Pat. No. 5,271,163 A and U.S. Pat. No. 5,532,335, assigned to the assignee of the instant application. Such an apparatus can be used for treating material, for example, in the course of drying, heating, cooling, reacting and recrystallizing materials. This apparatus comprises a plurality of paddles or vanes mounted on the rotatable shaft, and these extend substantially to the inside wall of the vessel.

Another type of mixing apparatus includes a mixing shaft with a plurality of blades, wherein the flow of material in the mixing apparatus is in a generally vertical orientation. In such a mixing apparatus, granular material can be coated and/or mixed with a spray liquid delivery system and moved along the vertical direction assisted by gravity. An example of such an apparatus is described in U.S. Pat. No. 4,810,099, assigned to the assignee of the instant application. In such a system, due to the vertical orientation and gravity feed, the solid may cloud the coating chamber, and the liquid may be sprayed at a single point (e.g., near the top of the coating chamber), and may contact the walls of the coating chamber before contacting the solid, resulting in uneven and/or inefficient mixing.

What is clearly needed is an improved systems and processes for coating and/or mixing particulate with liquids to provide useful products, and particularly in a manner that improves performance and corresponding economics, e.g., by optimizing such things as transport, residence time, density and dimensions of the product and the like.

### SUMMARY

The present disclosure provides an apparatus for use in mixing or coating particulate or powder material with one or more liquid materials, and preferably bulk liquid materials, in a manner that can provide an improved and optimal combination of properties as compared to apparatuses previously known, including in terms of mixing parameters (e.g., residence time and uniform liquid distribution), coating parameters (e.g., controllability, coating uniformity, particle size, particle density) and operational parameters (e.g., reduced and controllable energy input, minimizing material build up, productivity, cost of construction, and ease of use). In turn, the invention provides a method of making a coating apparatus and a method of using an apparatus as described herein, as well as a coated product made using an apparatus of this invention.

In one preferred embodiment, the coating apparatus comprises a coating chamber for receiving a particulate material and for mixing the particulate material with one or more liquids, preferably bulk liquids, under conditions suitable to form liquid coated particles, the chamber being adapted to substantially minimize the formation of caked liquid-solid mixture on its inner surface. As used herein, particulate material refers to solids, e.g., in granular form. A powder, in turn, is generally a granular medium made of particles less than about 100 microns in diameter, while a granular solid is composed of granules whose size ranges from about 100 to about 3000 microns.

In one such embodiment, the apparatus comprises a horizontally-oriented rotor rotatable about a longitudinal axis, the rotor being centrally positioned in the coating chamber, with the rotor having a plurality of mixing paddles mounted thereon. The apparatus further comprises a controllable system for delivering liquid along a path from a liquid metering source to the chamber interior, and in turn, onto the particulate material. The rotor can be configured such that the liquid can be delivered into the coating chamber at a desirable location, or multiple locations, in the coating chamber having a controllable trajectory so as to maximize the contact between liquids and solids. Optimal combination of liquid characteristics (e.g., viscosity, density, temperature and the like) and delivery characteristics (e.g., delivery flow rate or velocity, supply pressure of the liquid, size of the liquid injection path) can be controlled by controllable system for liquid delivery. Unless otherwise indicated, the term “bulk liquid” when used herein will refer to a liquid having low viscosity with or without dissolved solids, and can include, for instance to liquid materials that are delivered in the form of a liquid or atomized form, as by the use of nozzles, hydraulic atomizers or injectors designed for such purposes. As used herein, low viscosity refers to viscosity of the liquid that maximizes mixing between the solid and the liquid, for instance, between about 1 centipoise and about 100,000 centipoise, preferably between about 10 centipoise and about 20,000 centipoise, and more preferably about 100 centipoise, wherein the numerical values of viscosity mentioned herein are measured at the entrance to the coating apparatus (e.g., at the point of entrance of the liquid from the rotor).

In one such embodiment, for instance, the apparatus can comprise a pressurized liquid metering delivery source in fluid communication with a liquid injection path to deliver liquid through the rotor, to a plurality of apertures in the rotor and/or paddles, and into contact with particulate material within the apparatus chamber. Advantageously, the liquid can be injected at multiple points in the coating chamber. Applicant has discovered the manner in which delivery of liquid in this manner can provide significant properties and unexpected advantages over, for instance, the delivery of fluids in vertical coating apparatus, which tends to be common in the art. For instance, the liquid enters in liquid phase into a central aperture of the rotor, and flows into apertures/passages defined on the paddles, and leave the apertures of the paddles as a liquid. The liquid leaves the paddles in a continuous fashion (e.g., as a stream) or intermittently as droplets, and directly contacts the solid material. No air is introduced with this manner of liquid injection. The liquid injection system according to some preferred embodiments allow uniform and steady/continuous contact of liquid and solid, leading to a more efficient mixing than that can be permitted by vertical mixing apparatus using air atomized nozzles or horizontal mixing apparatus without a flexible wall. Advantageously, the liquid is introduced at various points (e.g., axial locations along the longitudinal axis of the rotor) in the coating chamber preventing local overwetting, leading to more uniform coating, more uniform liquid distribution and more uniform final product particle size distribution.

In yet another preferred embodiment, the coating chamber comprises a wall that is operably deformable, in order to release any caked solid-liquid mixture that adheres to the flexible wall.

In yet another preferred embodiment, some or all of the paddles can be angled relative to the longitudinal axis of the rotor to direct material flow from one end of the coating chamber to an opposite end of the coating chamber.

These and other features can be provided by means of a corresponding array of features and functions, e.g., the use of a horizontal material flow path, in which liquid can be injected to directly and continuously contact the particulate material in the coating chamber and the mixing chamber itself provides a flexible wall that can be deformed in order to minimize material buildup. In contrast with the limitations and disadvantages that can be encountered with prior methods, particularly when used with/to liquid-absorbent materials, the apparatus and method of this invention can provide continuous movement, uniform coating(s), steady agitation of the particulate material, and providing the ability control the size and shape of coated solid.

In turn, the apparatus will typically comprise a vessel of the type described in aforementioned U.S. Pat. No. 5,271,163 A and U.S. Pat. No. 5,532,335. As set forth in those disclosures, the vessel is in a generally horizontal orientation, comprising an inlet for receiving the particulate, a rotor with paddles mounted thereon for mixing the material with solid, and an outlet for delivering the mixture to further processing such as heating and drying. By contrast, however, those disclosures are concerned largely with the delivery of fluid that was not coherent so as to allow uniform mixing of the solid and liquid, resulting in products that have low density and non-uniform shapes. Moreover, these disclosures do not address caking and may not be suitable for forming coated products that require long residence times. Advantageously, the present disclosure provides a liquid injection system wherein the liquid feed is injected in a controlled manner resulting in direct contact between the solid and liquid, controllable liquid trajectory and more efficient use of energy input into the coating apparatus due to uniform mixing. The liquid uniformly and generally continuously comes in contact with the particulate in the coating chamber. As used herein, the term “uniformly” refers to the velocity of the liquid leaving each paddle being generally equal. As used herein, the term “continuously” or “steadily” refers to a steady stream of liquid leaving the paddles and contacting the solid, as opposed to break-up of the stream into intermittent droplets of liquids atomized by air atomizers typically caused by nozzle fouling. The liquid can be supplied through a liquid injection path defined along the rotor and the paddles to directly contact, coat and mix with the solids. Advantageously, the liquid injection path follows a controllable trajectory without introducing air that maximizes mixing with the solid. Horizontal orientation of the coating chamber permits longer residence times relative to those observed in vertically oriented coating chambers. The liquid injection system substantially reduces plugging or caking associated with conventional coating apparatuses, where nozzles are located within the material stream.

The apparatus will typically, and preferably, also provide a deformable wall of the coating chamber. By contrast, U.S. Pat. No. 4,810,099 describes the use of an elongated vertical flexible wall, though in the context of a vertical housing. However, the vertically-oriented mixing apparatus of that disclosure is limited to uncontrolled trajectory of the liquid and the short residence times due to the vertical orientation, wherein gravity flow of the coated material results in short residence times, and lower mixing intensity between the solid material and the liquid.

A process of forming a granular product from a dry powder using the apparatus of the present disclosure preferably includes the steps of providing a horizontally-oriented coating apparatus that receives the dry powder, injecting a liquid through a central aperture defined on the rotor of the coating apparatus such that the liquid flows through the central aperture along a longitudinal axis of the rotor, out of apertures defined on select paddles, and directly contacts the dry powder without the introduction of air. The process also includes the steps of coating and/or mixing the dry powder with the liquid, thereby agglomerating the powder and conveying the wetted powder out of the coating apparatus by rotating the rotor.

A coated product made using an apparatus and process described in this disclosure can be characterized by its physical properties such as density, size, shape, and the like. Coated products made using apparatus and methods according to the present disclosure have a higher density and generally spherical shape relative to prior vertically oriented coating and mixing apparatus. Advantageously, the apparatus and process described herein allows coating or mixing materials that have a tendency to absorb liquid, swell and adhere to surfaces, such as super absorbent polymers.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic of an overall coating system according to some embodiments;

FIG. 2 is a side view cutaway of the coating system of FIG. 1 that illustrates all material feed systems, mixing chamber, mixing elements and flexible mixing chamber wall deforming mechanism removed;

FIG. 3 is a side elevation view of the solids material feed port, mixing chamber and discharge housing, with the wall deforming system of FIG. 1 and its housing removed;

FIG. 4 is a side elevation view of the system of FIG. 3 with the wall deforming mechanism shown;

FIG. 5 is a side view of a rotor of the coating system of FIG. 2 according to an embodiment;

FIG. 6 is an end view of the rotor of FIG. 5;

FIG. 7 is a schematic illustrating the flow of materials over the rows of paddles illustrated in FIG. 6;

FIG. 8A is a front end perspective view of an arcuate support member for deforming a wall of the coating chamber according to an embodiment; and

FIG. 8B is a side view of the arcuate support member of FIG. 8A and FIG. 4.

### DETAILED DESCRIPTION

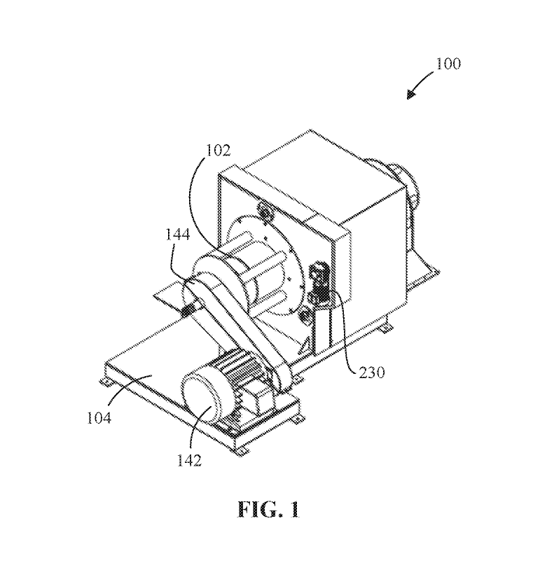

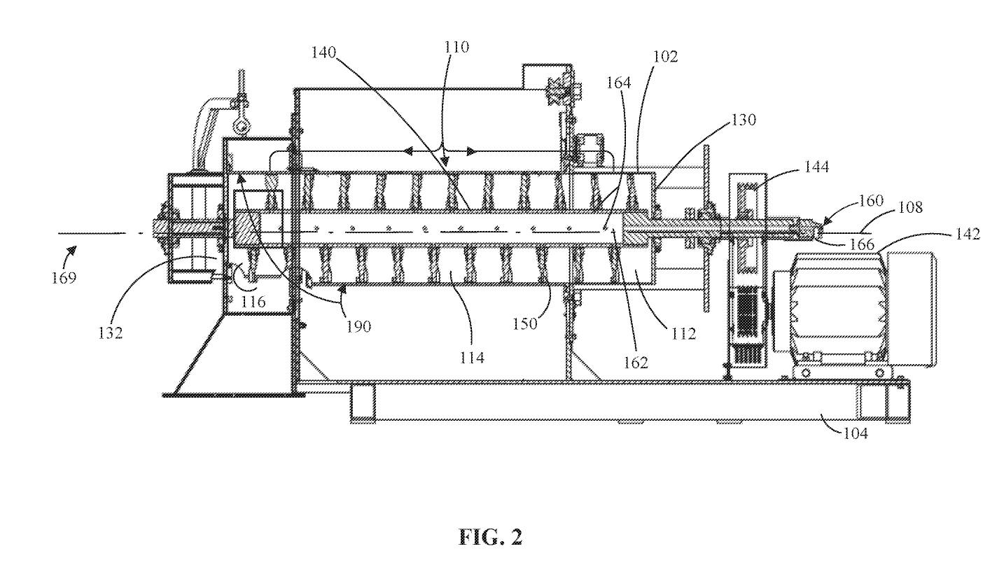

The disclosure will be further described with reference to the Figures, wherein FIG. 2 provides a schematic view of the overall coating system 100 of FIG. 1.

### Processing Apparatus

In one preferred embodiment, the overall coating system 100 comprises a housing 102 mounted on a base 104. The housing 102 is generally elongated in shape having a longitudinal axis 108 that is parallel to the plane on which the base 104 is mounted. As alluded to previously, the housing 102 is disposed in a generally horizontal orientation. Accordingly, the longitudinal axis 108 is parallel to a generally horizontal plane on which the base 104 is positioned.

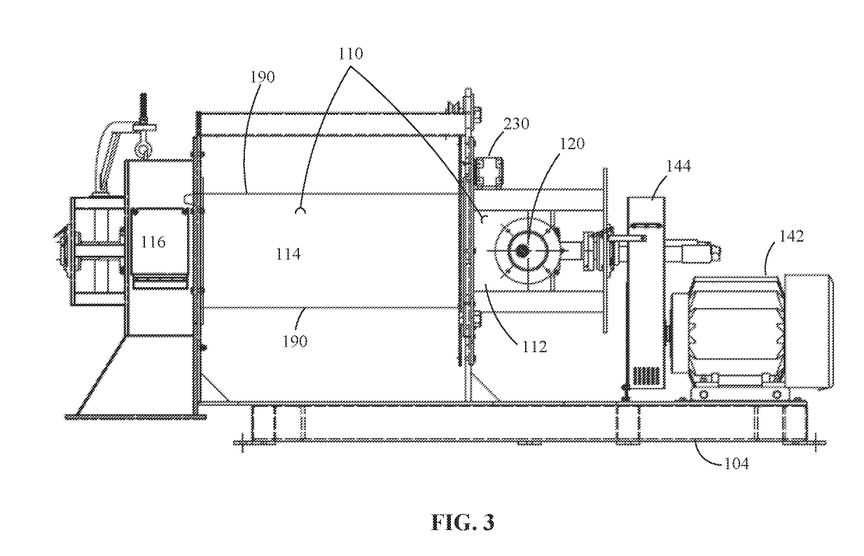

With continued reference to FIG. 2, the coating system comprises a coating chamber 110 in which a particulate material can be received. As used herein, the term “coating” chamber may refer to a chamber where particulate material can be coated or mixed. Hence, the term “coating chamber” can be used to refer to both coating chambers and mixing chambers. As shown therein, the coating chamber 110 can be divided into a feed zone 112 where the particulate material is introduced laterally to the view illustrated in FIG. 2, and a mixing zone 114 downstream of the feed zone 112 where the liquid is injected and directly contacts the particulate material in the coating chamber 110. In the illustrated embodiment of FIGS. 2 and 3, the particulate material is generally fed by a screw feeder (not shown) positioned on the housing 102 in the feed zone 112. As perhaps best seen in the detailed view of FIG. 3, the particulate can be fed via an inlet opening 120 positioned lateral to the plane of the coating chamber 110. While a screw feeder is the preferred embodiment and illustrated, a gravity feeder or other material delivery apparatus known to one skilled in the art can be used when appropriate.

Continuing with the schematic shown in FIG. 2, the particulate moves from one end of the coating chamber 110 (e.g., the material feed end 112 on the right side of FIG. 2) and is conveyed to the opposite end of the coating chamber 110 (e.g., the material delivery end 132 on the left side of FIG. 2). As the particulate moves generally along the longitudinal axis 108 of the housing 102, traveling generally in a thin turbulent layer along the periphery of coating chamber 110, it is coated and/or mixed with a liquid. A rotor 140 centrally disposed in the coating chamber 110 is to facilitate the movement of the particulate centrifugally against the chamber wall and longitudinally from inlet to outlet in the coating chamber 110. As seen in FIG. 1, the rotor 140 is coupled to a motor 142 by drive systems 144. While a belt drive system is illustrated any other drive systems (e.g., gears, direct coupling) known in the art are contemplated. The rotor 140 can be generally elongated and is configured for rotating about the longitudinal axis 108 of the housing 102. The rotor 140 can have a plurality of paddles 150 mounted thereon to agitate and disperse the particulate as it mixes with the liquid. Advantageously, the paddles 150 also facilitate physically moving the material along the direction illustrated in FIG. 2, as will be described further below. Such embodiments can, for instance allow for longer residence time, and thereby allow for better coating, mixing, shape forming and density adjustment.

As referred to above, the particulate enters the coating chamber 110 and is coated and/or mixed with a liquid therein. The coating apparatus according to some embodiments comprises an improved liquid injection system 160. The liquid injection system according to the present disclosure advantageously provides more uniform coating and/or mixing unlike known coating systems where liquids are injected into the coating chamber 110 from the outside of the mixing chamber as opposed to from within the mixing chamber, either by liquid nozzle or by spray atomizing. As described previously, the term “bulk liquid” as used herein refers to liquid streams that do not undergo atomization and break up into droplets. Both bulk liquid injection and spray atomization are contemplated in the present disclosure, but in either case, the liquid injection system can inject the liquid along a controllable trajectory, by initiating liquid injection from the rotor. As a result, the liquid can continuously mix with or coat the particulate as it leaves the liquid injection path and enters the coating chamber 110, resulting in improved and more uniform mixing relative to coating apparatuses and processes known in the art.

Additionally, the liquid injection system according to embodiments of the present disclosure allows for controlling the position at which the liquid contacts the particulate. As illustrated herein, the liquid enters the coating chamber 110 in the mixing zone 114, from the rotor, thereby reducing caking/plugging of liquid-solid mixture from occurring in the mixing zone 114. Moreover, by having the liquid directly contact the particulate in the coating chamber 110, the liquid injection system according to some embodiments facilitates uniform coating and/or mixing of the particulate unlike spray atomizing injectors well-known in the art.

As illustrated in FIG. 2, the liquid injection system according to certain embodiments of the present disclosure is injected in a direction along the longitudinal axis 108 of the housing 102. For instance, as illustrated, the rotor 140 can be generally hollow cylinder, with a central aperture 162 defined thereon. The rotor 140 can have a central aperture 162 with dimensions sufficient to carry the liquid at predetermined flow rates and pressures. The liquid can be fed through the central aperture 162 and flow out of apertures 164 defined on the paddles 150 and directly contact the particulate in the coating chamber 110. Liquid feed systems driven by the motor 142 can be used for pulling the liquid through the central aperture 162 of the rotor 140 from a liquid feed end. The liquid feed system such as those contemplated herein can have a reservoir and a pump (not shown) along with associated electrical and fluid controls in fluid communication with the central aperture 162 of the rotor 140 to pump the liquid with desired flow characteristics (e.g., flow rate, pressure, and the like). For instance, FIG. 2 illustrates a fluid connection system 166 for fluidly connecting the liquid feed.

In the illustrated embodiment, the liquid feed end is proximal to and downstream of the inlet opening 120. By injecting the liquid feed downstream of the particulate, the material feed end 130 of the coating chamber 110 is free of liquids. In turn, such a liquid feed configuration substantially reduces the chances of the material zone 112 from becoming plugged with solid/liquid mixture (e.g., in slurry or cake form), in turn substantially facilitating the material in freely moving along the longitudinal axis 108 from the material feed zone 112 to the discharge end unlike in conventional spray atomizing injector systems where the direction of liquid injection is not controlled. Conversely, the liquid feed system according to embodiments of the present disclosure facilitates controlling the direction and properties (e.g., flow rate, pressure, and other physical properties) of the liquid feed such that portions of the coating chamber 110 in the feed zone 112, (e.g., proximal to the material feed end 130) are generally dry. Such embodiments are especially beneficial in coating materials such as superabsorbent polymers and clays that have a tendency to become sticky and plug the machine or block liquid flow from immersed liquid injectors.

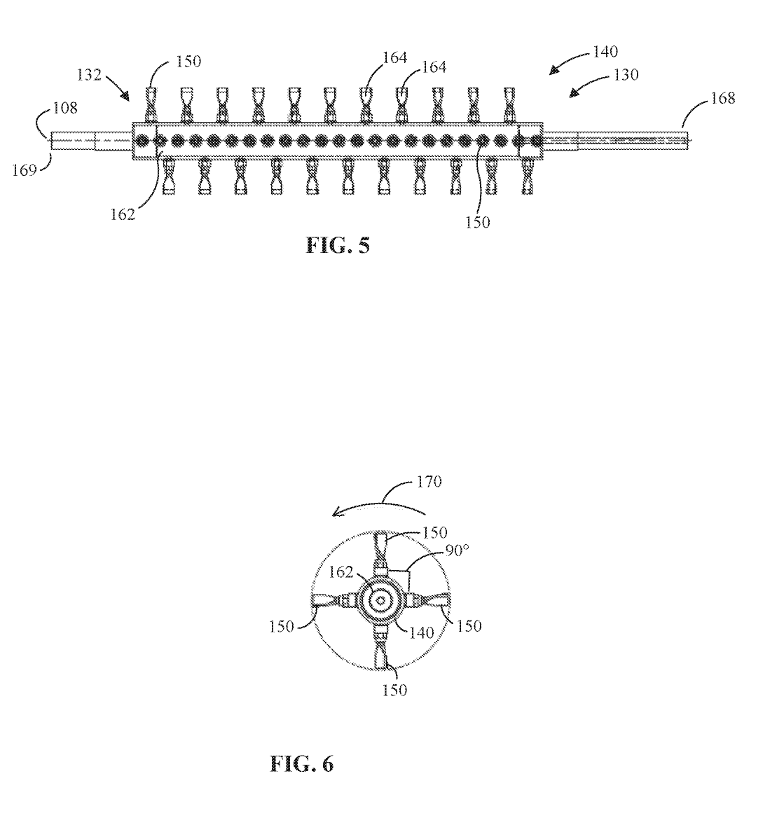

In the illustrated embodiment, a single liquid is injected in the central aperture 162 of the rotor 140. Additional embodiments are also contemplated as will be described below. In one embodiment, a single liquid can be injected from opposite sides (e.g., near ends 168 and 169) of the rotor 140 into the central aperture 162. Alternatively, and referring to FIG. 5, two liquids (e.g., miscible or immiscible liquids) can be injected from opposite ends 168, 169 of the rotor 140, such that a first liquid forms an initial coating on the particulate, and as the solid moves further downstream from the location of the first liquid, it can come in contact with a second liquid that can form a subsequent coating layer or initiate a reaction on the particulate coated with the first liquid.

Referring back to FIG. 2, as mentioned previously, the rotor 140 has a plurality of paddles 150 mounted thereon. The paddles 150 can each selectively have an aperture 164 in fluid communication with the central aperture 162 of the rotor 140 such that the liquid injected into the central aperture 162 of the rotor 140 flows via the aperture 164 in the paddles. The liquid can then leave the paddle via apertures 164 of the paddles 150, and directly contact the particulate in mixing zone 114 of coating chamber 110. As the liquid directly contacts the particulate, coating and/or mixing can be uniform, thereby substantially reducing undesirable effects such as plugging of caked liquid-solid mixture, blockages and the like, and keep the coated and/or mixed material freely flowing from the material feed zone 112 to the discharge end. The apertures 164 of the paddle can be of a size to provide a uniform rate and velocity of the liquid as it leaves each paddle.

Referring now to the side elevation view of FIG. 5 and the end view of FIG. 6, the rotor 140 according to some exemplary embodiments is generally elongated, with paddles 150 mounted on its outer surface at various circumferential locations. For instance, as seen in FIG. 6, the paddles 150 can be arranged in rows around the circumference of the outer surface of the rotor 140 at a spacing of about less than or about equal to 90 degrees there between. In FIG. 6, the direction of rotation of the rotor 140 is indicated by the arrow 170. Additional or fewer paddles 150 are also contemplated based on the desired coated or mixed product consistency.

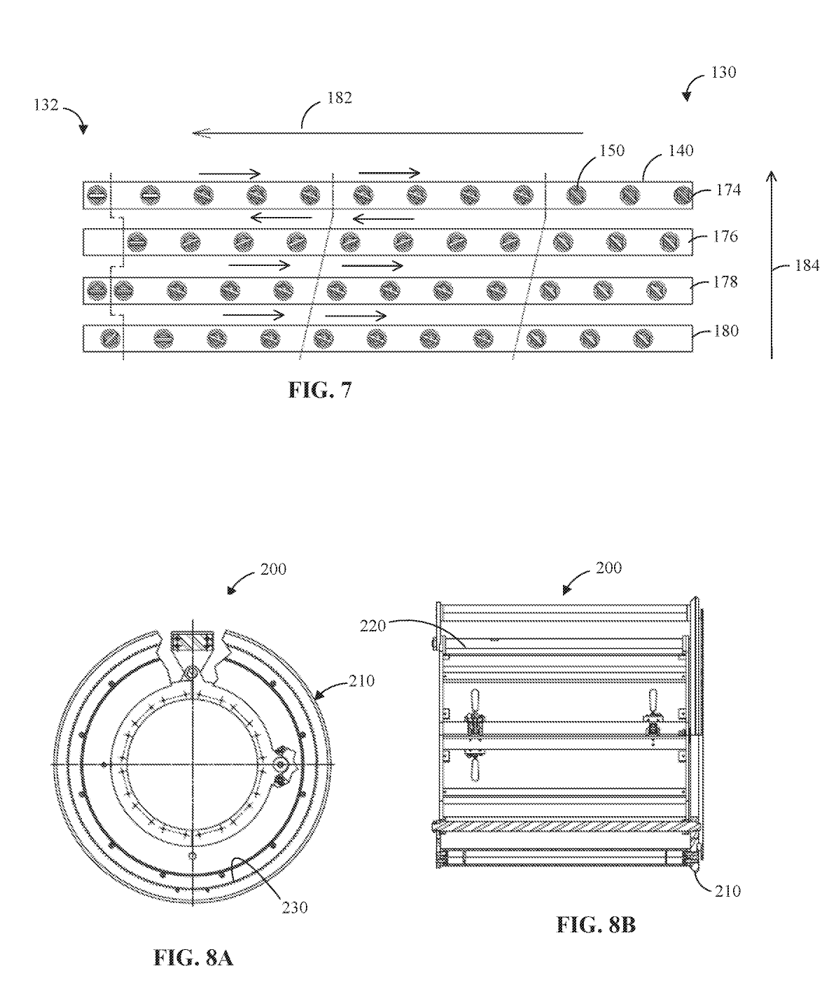

As best seen in FIG. 5 and referring now to the schematic of FIG. 6, the paddles 150 on the rotor 140 can be adjusted to facilitate optimal flow of the material. For instance, the paddles 150 can be adjusted such that they move the material longitudinally in the coating chamber 110 from the material feed end 130 to the discharge end. For instance, paddles 150 can be angled relative to a plane normal to the longitudinal axis 108 such that they direct the material in a generally forward direction. In this context, a generally forward direction is defined as one where the material flows from the material feed end 130 to the discharge end, and is shown by the arrow 182 in FIG. 7. In FIG. 7, the direction of rotation of the rotor 140 is shown by arrow 184. In such cases, the angle of each row 174, 176, 178, 180 of paddles 150 (or each paddle) relative to the plane normal to the longitudinal axis 108 can be varied. For instance, each row 174,176, 178, 180 of paddles 150 can have an angle relative to the plane normal to the longitudinal axis 108 that is different from adjacent rows 174,176, 178, 180 of paddles 150.

Continuing with the foregoing description, in FIGS. 5 and 7, for instance, the plane normal to the longitudinal axis 108 in the present example can be the plane of the paper. The paddles 150 near the material feed end 130 can be angled between about 15 degrees and about 60 degrees, and preferably about 45 degrees from the plane normal to longitudinal axis 108 (e.g., facing away from the plane of the paper) such that they move the particulate forward. As shown in FIGS. 5 and 7, the angles of paddles 150 on each row 174, 176, 178, 180 can be adjusted to a desired value. For instance, the paddle 150 can be angled 0 degrees over a first length of the rotor 140, 22 degrees over a second length of the rotor 140, 45 degrees over a third length of the rotor 140 as illustrated. Additionally, each row 174, 176, 178, 180 of paddles 150 can be angled differently relative to adjacent rows 174, 176, 178, 180 of paddles 150. Referring back to FIG. 2, in some specific embodiments, the angle of the paddles near the material feed end 130 can be opposite to the angle of the paddles near the discharge end.

Referring again to FIG. 2, the coating chamber 110 can have a flexible wall 190 to substantially reduce build-up of any material that adheres to the walls of the coating chamber 110. The flexible wall 190 can be flexible relative to the housing 102 in feed zone 112. According to one of the aspects of the present disclosure, the coating system incorporates a deforming system 200 for flexing or deforming the flexible wall 190 to substantially reduce accumulation of materials on the surface of the flexible wall 190. As will be appreciated, the mixing zone 114 of coating chamber 110 is designed especially for coating or mixing a powdered material with a liquid or binder material, to produce granules of a predetermined size. Thus, the mixture or coated material may tend to adhere to the inner surface of the coating chamber 110 particularly in mixing zone 114 defined by the flexible wall 190.

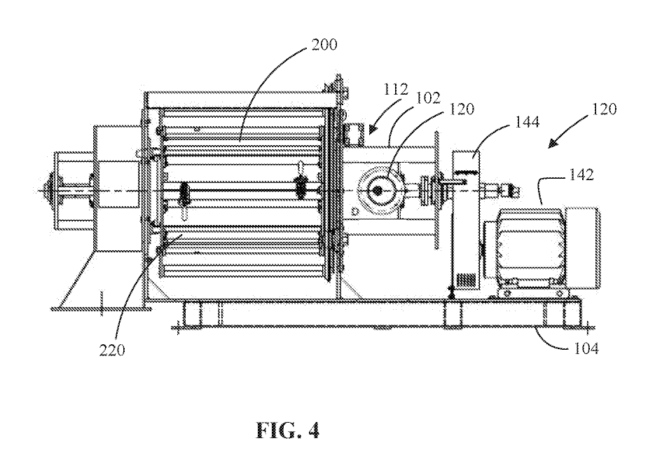

In the specific embodiment illustrated in FIG. 4, and referring now to FIGS. 8A and 8B, the deforming system 200 consists of a generally arcuate support member 210 that extends at least partially around the flexible wall 190 and has one or more deforming member 220 rotatably supported thereon. The generally arcuate support member 210 can be shaped in the form of a cylindrical roller cage. An exemplary roller cage system is described in U.S. Pat. No. 4,810,099 assigned to the assignee of the instant application which is incorporated herein by reference. The deforming members 220 can preferably be spindle-shaped, and can deform by pressing against the flexible wall 190. All deforming member 220 can be actuated by a drive system 230 (e.g., gearmotor, gears, sprockets and the like) to rotate deforming members 220 continuously around the flexible wall 190 at an adjustable speed. In turn, the deforming members 220 can be adjusted radially to press against the flexible wall 190. Advantageously, the flexible wall 190 can be made of a material flexible relative to other components of the coating chamber 110 (or the housing 102) such that the flexible wall 190 deforms radially. This radial inward deformation can in turn break off or peel off any caked solid-liquid mixture adhering to the walls of the flexible wall 190. The deforming system 200 selectively deforms the flexible wall 190 such that any material that adheres thereto is broken up due to deformation of the flexible wall 190.

Preferably, the flexible wall 190 can be made of a polymer material such as natural and synthetic deformable rubbers such as silicone, ethylene propylene diene monomer (EPDM), acrylonitrile butadiene (commercially available as “nitrile”), fluoropolymer (commercially available as “Viton”) rubbers, elastomers, and synthetic polymers such as polyurethane. Optionally, the central rotor 140 and the paddles 150 can also be coated with a polymer material as the flexible wall 190 to substantially reduce the chances of material adhering thereto, particularly when the liquid is injected via apertures 164 on the paddles 150.

Once the material is coated and moved toward the discharge end, it can be discharged by means well known in the art, and subsequently processed (e.g., drying, thermal treatment, size reduction and the like).

In the following section, a few exemplary coating and mixing processes will be described.

### EXAMPLES

An exemplary embodiment of a process for forming granular material by coating, mixing and thermally treating dry powders with a liquid coating agent in accordance with the embodiments disclosed herein is described below. An exemplary embodiment of a process for forming a granular material by agglomerating dry powders by mixing with a liquid binding agent, followed by drying and sifting is also described.

### Description of Particulate Feed

In one example, the particulates can comprise super-absorbent polymer (SAP). The particulates can be characterized by particle sizes between about 100 micron and 850 micron with an average size of about 350 micron. The powder is fed by the screw feeder into the coating chamber 110 at bulk density of between about 35 pounds per cubic foot at about 2% moisture. Other examples are powders used in chemical processing such as minerals, clays or pigments (e.g., iron oxide powder). Clay powder can be characterized by particle sizes between about 10 micron and about 100 micron with an average size about 25-30 micron and fed by the screw feeder into the coating chamber 110 at bulk density of between about 46 pounds per cubic foot and about 53 pounds per cubic foot at about 8% moisture.

### Description of Liquid Feed System

The liquid feed system for SAP can be a coating agent and include water and an alcohol solution containing water and a water soluble polymer and has a viscosity of between about 1 centipoise (e.g., viscosity of water) and about 1,000 centipoise. The liquid is pumped from a reservoir on a scale using a metering pump. Liquid enters the rotor 140 and flows through the central aperture 162, via the aperture 164 defined in the paddles 150 and directly contacts the dry powder. As the liquid mixes with the powder, it coats and forms agglomerates. The coated material is conveyed by the rotation of the paddles 150 from the material feed end 130 toward the discharge end wherein in is dispensed. The residence time of the material in the coating chamber 110 can be between about 2 seconds and about 60 seconds, and preferably about 4 seconds, with all paddles adjusted to convey material to the discharge, due to rapid swelling of this material on contact with liquid. Any material that adheres to the flexible wall 190 can be broken by deforming at least a portion of the flexible wall 190 by actuating the roller cage. Coated product moistures ranged from 4% to 7% before being subjected to further processing such as drying, heating, cooling, and the like. This being a surface treatment, (i.e. coating) there was very little change in particle size and density. Energy consumption was on the order of 0.5 hp/ton/hr to 3.5 hp/ton/hr, with higher energy associated with the higher moisture product. Operating tip speed of the mixer was 2400 ft/minute. This compares to 8.5 hp/ton/hr for a vertical mixer using air atomized nozzles, operating at 4700 ft/minute tip speed, and coating at 4% final moisture content.

The granular product formed according to the foregoing exemplary methods processing clay powders can be characterized by material density changing by about 12% to as much as 47%, increasing from the start of the agglomerating process to the end of the agglomerating process, wherein the density is measured on a dry weight basis. Clay powders were wetted using water addition as described above, with 6 paddles used as injectors, increasing the feed powder from 8% moisture to a final moisture range of from 17% moisture to 22% moisture. The optimum moisture content for the wetted material is in the range of 18%-19% to maximize the granular product with a particle size range between about 850 microns and about 2400 microns upon drying. Resultant particle shape is generally spherical. Final density range starting from 46 lb/ft³ was 52-64 lb/ft³ and starting from 53 lb/ft³ was 60-62 lb/ft³.

Embodiments such as those disclosed herein can allow for one or more advantages. A horizontally oriented coating apparatus such as those described herein can facilitate longer residence times of the material and in turn, a higher density of products formed in comparison to vertically oriented (e.g., gravity fed) coating apparatus. The liquid injection system taught herein can facilitate injecting liquids in a controlled manner to provide more uniform mixing than spray atomizing injector systems. Moreover, such controlled injection of liquid substantially reduces plugging and material build-up resulting in moving the material in the coating chamber in a smooth and efficient manner. Additionally, the coating apparatus taught herein, with mixing chamber wall continuous cleaning by the deforming mechanism greatly reduces build-up of material resulting in reduced energy to achieve equivalent or better mixing, extended wear life of mixing elements and therefore increased productivity at reduced operating cost.

Various examples have been described. These and other examples are within the scope of the following claims.

1. A coating apparatus comprises a horizontally-oriented rotor rotatable about a longitudinal axis, the rotor being centrally positioned in the coating chamber, with the rotor having a plurality of mixing paddles mounted thereon, the apparatus further comprises a controllable system for delivering liquid along a path from a liquid source to the chamber interior, and in turn, onto the particulate material, the liquid traveling in the coating chamber along a predetermined liquid trajectory in the coating chamber, the liquid trajectory being controllable by the controllable system.

2. The coating apparatus of claim 1, wherein the liquid injection path is defined such that liquid flowing therethrough directly contacts the particulate.

3. The coating apparatus of claim 1, wherein the coating chamber comprises a flexible wall, the flexible wall being continuously deformable to release any mixture of particulate and liquid that adheres to the flexible wall of the coating chamber.

4. The coating apparatus of claim 1, wherein the paddles are angled relative to the longitudinal axis of the rotor to direct material flow from one end of the coating chamber to an opposite end of the coating chamber.

5. The coating apparatus of claim 1, wherein the rotor is substantially hollow, the rotor defining a central aperture that forms a portion of the liquid injection path.

6. The coating apparatus of claim 5, wherein the central aperture of the rotor is configured for receiving liquids from two opposing ends thereof.

7. The coating apparatus of claim 6, wherein a first liquid is injected from one end of the central aperture, and a second liquid is injected from an opposite end of the central aperture.

8. The coating apparatus of claim 1, further comprising a material feed apparatus mounted to a first end of the coating chamber, the material feed apparatus dispensing particulate in powder form into the coating chamber.

9. The coating apparatus of claim 8, wherein the liquid injection path is arranged such that liquid contacts the solid powder downstream of the location where the particulate is dispensed into the coating chamber.

10. The coating apparatus of claim 1, wherein the paddles are configured on the rotor such that the rotation of the rotor causes the paddles to agitate the mixture of solid and liquid material and thereby reduce adhering of the mixture to the walls of the coating chamber.

11. A coating apparatus comprising:
a coating chamber configured for receiving a particulate;
a horizontally-oriented rotor rotatable about a longitudinal axis, the rotor having a plurality of paddles mounted thereon, the rotor and the paddles defining a liquid injection path fluidly connected to a liquid injection system, the liquid injection system arranged to supply a liquid under conditions suitable to continuously coat the particulate in a manner that substantially reduces formation of caked solid-liquid mixture on inner walls of the coating chamber.

12. A process of forming a granular product from a dry powder, comprising:
providing a horizontally-oriented coating apparatus that receives the dry powder, the coating apparatus having a coating chamber, a hollow rotor with a plurality of paddles mounted thereon;
injecting a liquid through a central aperture defined on the rotor, the liquid flowing through the central aperture along a longitudinal axis of the rotor, the liquid flowing out of apertures defined on each paddle, and directly contacting the dry powder;
coating and/or mixing the dry powder with the liquid, thereby binding the powder; and
conveying the mixture of dry powder and liquid out of the coating apparatus by rotating the rotor.

13. The process of claim 12, wherein the mixture of dry powder and liquid is conveyed at a rate sufficient to form a granular product with a density change of about 20% from the start of the coating process to the end of the coating process, wherein the density is measured on a dry weight basis.

14. The process of claim 12, wherein the mixture of dry powder and liquid conveyed at a rate sufficient to form a granular product, wherein the granular product has agglomerates of generally spherical shape.

15. The process of claim 12, wherein the coating apparatus comprises a flexible wall, the flexible wall being deformed radially inwardly toward the central rotor to break any mixture of dry powder and liquid that adhere thereto.

16. The process of claim 12, further comprising, injecting a first liquid from a first end of the central aperture of the rotor, and injecting a second liquid from a second of the central aperture of the rotor.

17. The process of claim 16, wherein the first and second ends are opposite to each other.

18. The process of claim 16, wherein the first and second liquids are miscible.

19. A granular product formed according to the process of claim 12.

20. The granular product of claim 19, wherein the product is generally spherical.
